(19) United States
(12) Patent Application Publication
(10) Pub. No.: US 2026/0209630 A1
(43) Pub. Date: Jul. 23, 2026

(54) SYSTEM AND METHOD FOR PRODUCING A LUBRICATING GREASE USING ELECTROMAGNETIC INDUCTION

(71) Applicant: JAX Inc., Menomonee Falls, WI (US)

(72) Inventors: Andrew Heimer, Roscoe, IL (US); John Toberman, Janesville, WI (US); Kyle C. Peter, Shorewood, WI (US); Eric J. Peter, Elm Grove, WI (US)

(73) Assignee: JAX Inc., Menomonee Falls, WI (US)

(21) Appl. No.: 19/138,876

(22) PCT Filed: Jan. 2, 2024
(86) PCT No.: PCT/US2024/010048

§ 371 Date: Jun. 13, 2025

Related U.S. Application Data
(60) Provisional application No. 63/478,539, filed on Jan. 5, 2023.

(51) Int. Cl. C10M 177/00; B01J 19/00; B01J 19/08; C10M 169/02; C10M 169/04

(52) U.S. Cl. CPC C10M 177/00; B01J 19/0013; B01J 19/0066; B01J 19/087; C10M 169/02; C10M 169/042; B01J 2219/00058; B01J 2219/00139; B01J 2219/0871

(57) ABSTRACT

A system (10) for producing lubricating grease comprises a first kettle (12) configured to receive a base oil and one or more thickening agents therein, the base oil and the one or more thickening agents together forming a slurry. An induction coil (138) is disposed around an outer circumferential surface (120) of the first kettle (12). A power supply (42) is electrically coupled to the induction coil (138) and configured to provide power to the induction coil (138) so as to heat the first kettle (12). The first kettle (12) is configured to mix the slurry while the first kettle (12) is heated via electromagnetic induction under conditions suitable to form a dispersion.

### FIELD

The present application relates to systems and methods for producing lubricating grease.

### BACKGROUND

Heat is required for chemical reactions to take place while manufacturing certain types of lubricating grease. Lubricating grease is manufactured in large mixing kettles, which are typically jacketed with either a circulating hot oil system or a boiler-fed steam system to provide the heat. Even older methods involved direct fire heating of the kettle. Depending on the thickener formed, the contents of the kettle can reach temperatures up to 400° F.

More recently, it has been proposed to use microwave energy to heat vegetable oils for grease processing. For example, U.S. Pat. No. 8,962,542 discloses a process and corresponding apparatus and system for use in preparing soaps from fatty acid containing oil compositions, and in turn, for preparing greases by the use of such soaps in combination with one or more base oils.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

According to one example, a method for producing a lubricating grease comprises providing a base oil, heating the base oil, and adding one or more thickening agents to the heated base oil to form a slurry. The method includes mixing the slurry in a first kettle while heating the first kettle via electromagnetic induction under conditions suitable to form a dispersion. The method also includes adding further ingredients to the dispersion under conditions suitable to form a lubricating grease.

According to one aspect, the one or more thickening agents comprise two or more thickening agents, and the step of mixing the slurry in the first kettle while heating the first kettle causes the two or more thickening agents to react so as to form one or more reaction products. In one example, one of the one or more reaction products comprises water, and the method further comprises heating the first kettle via electromagnetic induction so as to evaporate the water from the dispersion.

According to one aspect, heating the first kettle via electromagnetic induction comprises providing power to an induction coil configured to heat the first kettle, and the method further comprises controlling the power provided to the induction coil with a controller. In one example, the method further comprises monitoring a temperature of contents of the first kettle with a temperature sensor, comparing the temperature of the contents of the first kettle to a predetermined setpoint temperature with the controller, and controlling the power provided to the induction coil so as to maintain the contents of the first kettle within a predetermined range of the predetermined setpoint temperature. In one example, the predetermined range is five degrees Fahrenheit. In a preferred example, the predetermined range is two degrees Fahrenheit.

According to one aspect, the method further comprises stopping providing power to the induction coil prior to the step of adding further ingredients to the dispersion. In one example, the further ingredients include further amounts of the base oil, and the method further comprises adding the further amounts of base oil to the dispersion within the first kettle so as to quench the dispersion and subsequently transferring the quenched dispersion to a second kettle and adding even further amounts of the base oil to the second kettle.

According to one aspect, the induction coil is disposed around an outer circumferential surface of the first kettle.

According to another example of the present disclosure, a system for producing lubricating grease comprises a first kettle configured to receive a base oil and one or more thickening agents therein, the base oil and the one or more thickening agents together forming a slurry. An induction coil is disposed around an outer circumferential surface of the first kettle. A power supply is electrically coupled to the induction coil and configured to provide power to the induction coil so as to heat the first kettle. The first kettle is configured to mix the slurry while the first kettle is heated via electromagnetic induction under conditions suitable to form a dispersion.

According to one aspect, the system further comprises a controller configured to control the power supply.

According to one aspect, the system further comprises a temperature sensor configured to sense a temperature of contents of the first kettle. The controller is configured to compare the temperature of the contents of the first kettle to a predetermined setpoint temperature. The controller is configured to control the power supply so as to control the power provided to the induction coil to maintain the contents of the first kettle within a predetermined range of the predetermined setpoint temperature. In one example, the predetermined range is five degrees Fahrenheit. In a preferred example, the predetermined range is two degrees Fahrenheit.

According to one aspect, the system further comprises a second kettle in fluid communication with the first kettle. The controller is configured to control the power supply to stop providing power to the induction coil before contents of the first kettle are transferred to the second kettle.

According to one aspect, the first kettle has a single-wall jacket defining the outer circumferential surface.

According to one aspect, the induction coil is disposed around a lower portion of the outer circumferential surface of the first kettle, but not around an upper portion of the outer circumferential surface of the first kettle.

According to one aspect, the induction coil does not contact the outer circumferential surface of the first kettle.

According to one aspect, the first kettle further comprises a motor-driven agitator for mixing contents of the first kettle.

Various other features, objects, and advantages of the invention will be made apparent from the following description taken together with the drawings.

### BRIEF DESCRIPTION OF THE DRAWINGS

The present disclosure is described with reference to the following Figures. The same numbers are used throughout the Figures to reference like features and like components.

FIG. 1 illustrates a system for producing grease according to the present disclosure.

FIG. 2 illustrates a control system associated with the system of FIG. 1.

FIG. 3 illustrates a method for producing grease according to the present disclosure.

### DETAILED DESCRIPTION

Before any embodiments of the invention are explained in detail, it is to be understood that the invention is not limited in its application to the details of construction and the arrangement of components set forth in the following description or illustrated in the drawings. The methods disclosed herein need not be performed in the order described or claimed unless otherwise specified or limited. The invention is capable of other embodiments and of being practiced or of being carried out in various ways. Many modifications and other embodiments of the invention set forth herein will come to mind to one skilled in the art to which the invention pertains having the benefit of the teachings presented in the following description and the associated drawings. Although specific terms are employed herein, they are used in a generic and descriptive sense only and not for purposes of limitation.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

Unless otherwise specified or limited, the phrases “at least one of A, B, and C,” “one or more of A, B, and C,” and the like, are meant to indicate A, or B, or C, or any combination of A, B, and/or C, including combinations with multiple instances of A, B, and/or C.

Unless otherwise specified or limited, the terms “mounted,” “connected,” “linked,” “supported,” and “coupled” and variations thereof are used broadly and encompass both direct and indirect mountings, connections, supports, and couplings, which may be mechanical and/or electrical.

As used herein, unless otherwise specified or limited, discussion of particular directions is provided by example only, with regard to particular embodiments or relevant illustrations. For example, discussion of “top,” “bottom,” “front,” “back,” “left,” “right,” “radial,” “lateral” or “longitudinal” features is generally intended as a description only of the orientation of such features relative to a reference frame of a particular example or illustration. Correspondingly, for example, a “top” feature may sometimes be disposed below a “bottom” feature (and so on), in some arrangements or embodiments. Additionally, use of the words “first,” “second”, “third,” etc. is not intended to connote priority or importance, but merely to distinguish one of several similar elements from another.

Ranges can be expressed herein as from “approximately” one particular value and/or to “approximately” another particular value. When such a range is expressed, another aspect includes from the one particular value and/or to the other particular value. Similarly, when values are expressed as approximations, by use of the antecedent “approximately,” it will be understood that the particular value forms another aspect. It will be further understood that the endpoints of each of the ranges are significant both in relation to the other endpoint, and independently of the other endpoint. Optionally, in some aspects, when values are approximated by use of the antecedent “approximately,” it is contemplated that values within up to 15%, up to 10%, up to 5%, or up to 1% (above or below) of the particularly stated value can be included within the scope of those aspects.

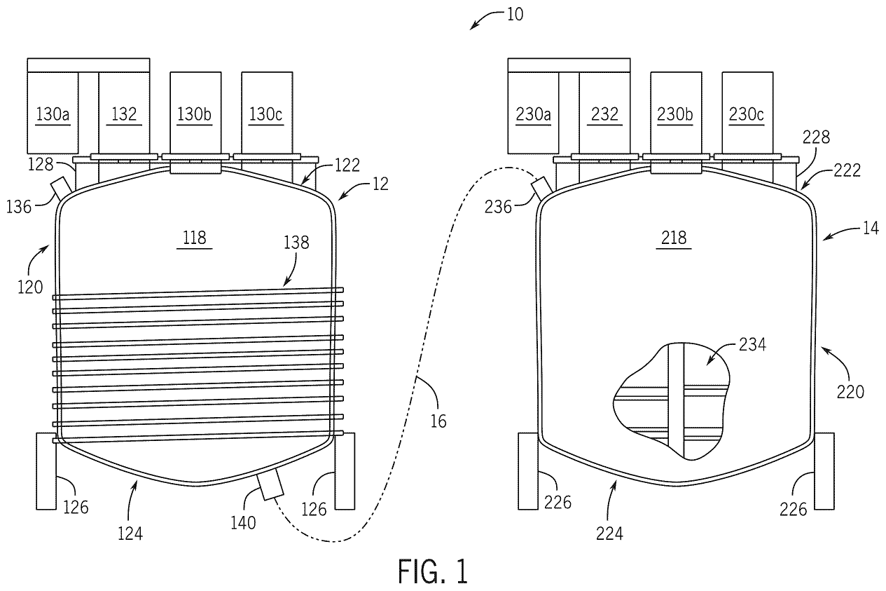

FIG. 1 illustrates a system 10 for producing lubricating grease. The system 10 comprises a first kettle 12 and a second kettle 14. In some examples, the first kettle 12 is considered to be a “reaction kettle” and the second kettle 14 is considered to be a “finishing kettle,” as will be described further herein below. The system 10 also includes pipes or other conveying structures, shown schematically at 16, for transferring contents of the first kettle 12 to the second kettle 14 during the grease manufacturing process.

The first and second kettles 12, 14 may generally have the same structure, with one key difference noted herein below. Only the first kettle 12 will be described in detail, it being understood that the same description applies to the second kettle 14 unless otherwise noted. Components and features of the first kettle 12 are referred to herein with a “1” in the hundreds place, while the same or similar features of the second kettle 14 are referred to with a “2” in the hundreds place and the same two numbers in the tens and ones places. The first kettle 12 comprises a cylindrical tank 118 having an outer circumferential surface 120. The tank 118 is made of metal, preferably stainless steel or carbon steel. As shown herein, the first kettle 12 is closed on the top and bottom ends 122, 124 of the tank 118, but in other examples, the first kettle 12 could be an open kettle that is open or partially open at its top end. If the tank 118 is closed, it may be pressurized. The tank 118 is supported on a supporting surface (e.g., floor) by legs 126. Only two legs 126 are shown, but three, four, or more legs could be provided.

A support bracket 128 or other supportive structure is provided on the top end 122 of the tank 118, which supports one or more motor-driven agitators for mixing any contents of the first kettle 12. Specifically as shown herein, the support bracket 128 supports three motors: a first motor 130a, a second motor 130b, and a third motor 130c. The first motor 130a is coupled to a hopper 132 via which particulate matter can be added to the tank 118. The first motor 130a drives a high-speed disperser (not shown) located in the tank 118 to disperse the particulate matter within the tank 118. The second motor 130b drives an agitator commonly referred to as an “anchor” that mixes the contents of the tank 118 (see agitator 234 shown in partial cutaway inside tank 218 of second kettle 14). The third motor 130c drives a high-shear rotor/stator mixer (not shown) also located inside the tank 118. The number and types of agitators shown herein are not limiting on the scope of the present disclosure.

The first kettle 12 is configured to receive a base oil and one or more thickening agents therein. As is known to those having ordinary skill in the relevant art, a lubricating grease generally comprises a base oil, one or more thickening agents, and any desired additives. The base oil may be natural or synthetic, and by way of non-limiting example can be mineral (e.g., naphthenic or paraffinic), non-mineral (e.g., vegetable-based), PAO-based, silicone-based, PAG-based, or ester-based. The one or more thickening agents will vary based on the application for which the grease is intended. In some examples, the thickener is the reaction product of carboxylic acid(s) and alkaline earth metal hydroxide(s), forming an organic salt (“soap”) by way of a process known as saponification. There are different types of soap thickeners used for lubricating greases, including calcium soap, sodium soap, aluminum soap, lithium soap, and complex forms of these. Non-soap thickeners can also be used, such as polytetra-fluoroethylene (PTFE), hectorite and bentonite clays, polypropylene, silica gel, polyethylene, polyurea, and calcium sulfonate. Additives may include antioxidants, anti-wear agents, and friction modifiers, to name a few.

The base oil may be supplied via a liquid inlet 136 located at the top end 122 of the tank 118. The thickening agents may be added via the liquid inlet 136 or via the hopper 132 and dispersed within the tank 118 via the high-speed disperser driven by first motor 130a. As is known in the art of grease manufacturing, the base oil and the one or more thickening agents together form a slurry within the tank 118. Typically at this stage in the process, the tank 118 would be heated by introducing hot oil or steam into a double-wall jacket surrounding the outer circumferential surface 120 of the tank 118 so as to create conditions suitable for mixing the thickening agents into the base oil and (in instances where required) producing a chemical reaction between certain of the thickening agents and/or between the thickening agents and the base oil. However, the present inventors have instead developed a system in which an induction coil 138 is disposed around the outer circumferential surface 120 of the first kettle 12. The first kettle 12 is configured to mix the slurry (e.g., using motor-driven agitators) while the first kettle 12 is heated via electromagnetic induction under conditions suitable to form a dispersion as part of the grease manufacturing process.

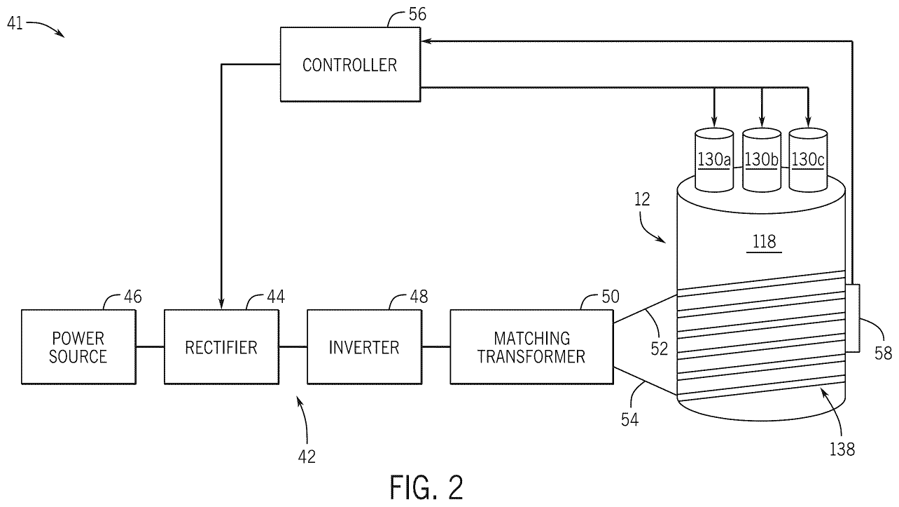

Turning to FIG. 2, a control system 41 for the grease-manufacturing system 10 of FIG. 1 is shown. The control system 41 includes a power supply 42 electrically coupled to the induction coil 138 and configured to provide power to the induction coil 138 so as to heat the first kettle 12. The power supply 42 includes a rectifier 44 configured to be connected to a power source 46 (e.g., an AC electrical power source). The rectifier 44 converts the AC power to DC power, which is passed to an inverter 48 of the power supply 42. The inverter 48 is a switching unit that converts the DC power to high-frequency AC power and may include solid state switches, such as IGBTs, for such purposes. A matching transformer 50 includes electrical components (e.g., capacitor, transformer, etc.) that match the impedance of the power supply 42 to that of the induction coil 138. Electrical power from the matching transformer 50 is provided through the induction coil 138 via electrical conductors 52, 54, which are connected to the terminals of the induction coil 138. The power supply 42 causes alternating current to flow through the induction coil 138 which, in turn, causes an alternating magnetic field to pass through the metal tank 118 of the first kettle 12. This magnetic field induces eddy currents in the metal tank 118, which is thereby heated internally by resistance heating. In some examples, the rectifier 44 and inverter 48 may be referred to as the “power supply” 42 and may be located in a separate unit/housing from the matching transformer 50. In other examples, the matching transformer 50 may be provided as part of the same unit and/or in the same housing as the rectifier 44 and inverter 48. Those having ordinary skill in the relevant art will understand that the electrical components described herein are exemplary only, and that different electrical components may be able to achieve the same end results.

A controller 56 is configured to control the power supply 42. The controller 56 may be part of the same unit and/or in the same housing as the power supply 42 or may be separate therefrom. The controller 56 may include a computing system that includes a processing system, storage system, software, and input/output (I/O) interfaces for communicating with peripheral devices, such as the rectifier 44, a temperature sensor 58, the motors 130a-c, and other devices. The systems may be implemented in hardware and/or software that carries out a programmed set of instructions. For example, the processing system loads and executes software from the storage system, such as software programmed with a temperature control method and/or a batch processing method, which directs the processing system to operate as described herein below in further detail. The processing system can comprise a microprocessor, including a control unit and a processing unit, and other circuitry, such as semiconductor hardware logic, that retrieves and executes software from the storage system. The storage system can include one or many software modules comprising sets of computer executable instructions for carrying out various functions as described herein. The storage system can comprise any storage media readable by the processing system and capable of storing software. The storage system can include volatile and non-volatile, removable and non-removable media implemented in any method or technology for storage of information, such as computer-readable instructions, data structures, software program modules, or other data. The storage system can include additional elements, such as a memory controller capable of communicating with the processing system. Non-limiting examples of storage media include random access memory, read-only memory, magnetic discs, optical discs, flash memory, virtual and non-virtual memory, various types of magnetic storage devices, or any other medium which can be used to store the desired information and that may be accessed by an instruction execution system. The storage media can be a transitory storage media or a non-transitory storage media such as a non-transitory tangible computer readable medium. In one particularly relevant example, the controller 56 is a programmable logic controller (PLC).

The induction coil 138 is a conductive element, preferably a copper-containing cable. The induction coil 138 may be jacketed or unjacketed. Although the induction coil 138 is shown herein as having only two terminals, the induction coil 138 alternatively may be a multicoil element with two terminals for each coil. In other examples, a single induction coil 138 may have multiple coil taps for electrical connection to the matching transformer 50. In either case, the result is that only a portion of the coil(s) provided around the first kettle 12 may be provided with electrical power, resulting in only a portion of the tank 118 being heated.

As noted, the system 41 further comprises a temperature sensor 58, which is configured to sense a temperature of contents of the first kettle 12. The temperature sensor 58 may be any suitable sensor, such as a thermocouple located in a thermowell in the outer circumferential surface 120 of the tank 118. In another example, the temperature sensor 58 may be a non-contact infrared temperature sensor configured to read the temperature of the contents of the tank 118. The temperature sensor 58 is electrically wired and/or wirelessly signally coupled to the controller 56 via the controller's I/O interface. According to a temperature control module stored in the storage system of the controller 56 and executed by the processing system, the controller 56 is configured to compare the temperature of the contents of the first kettle 12 to a predetermined setpoint temperature. The controller 56 is configured to control the power supply 42 so as to control the power provided to the induction coil 138 to maintain the contents of the first kettle 12 within a predetermined range of the predetermined setpoint temperature. The predetermined setpoint temperature may change depending on the step in the grease manufacturing process, as will be described further herein below.

In current grease manufacturing systems, if a thermocouple determines that the contents of a reaction kettle are within a predetermined range of a predetermined setpoint temperature, a human operator or a PLC will control a valve to shut off flow of steam or heat transfer oil to the jacket around the kettle. It takes time for the steam or hot oil already in the jacket to exit the jacket, after which the contents of the kettle begin cooling. Thus, depending on the kettle, it is possible that an operator or PLC may need to shut off the supply of heating medium to the jacket when the measured temperature of the contents of the kettle is 10° F. or more from the predetermined setpoint temperature. Often, such prior art systems experience thermal runaway due to the lack of accuracy inherent in temperature control with a flowing heating medium and/or due to an inexperienced operator or operator error. In contrast, as the controller 56 monitors the temperature of the contents of the present induction-heated kettle 12, the controller 56 can control the amount of heat supplied to the kettle 12 instantaneously, in real-time. For example, by use of a feedback loop, such as a PI or PID control loop, the controller 56 can control the power supply 42 to change the current, voltage, and/or frequency of power provided to the induction coil 138, resulting in smaller incremental changes to temperature and more instantaneous control over temperature than in prior art systems. This results in the predetermined range within which the controller 56 is able to maintain the temperature of the contents of the kettle 12 being much narrower than in prior systems. In one example, the predetermined range within which temperature of the contents of the kettle 12 can be maintained is five degrees Fahrenheit. Particularly, the predetermined range is two degrees Fahrenheit. Thus, induction heating provides very precise temperature control, while reducing operating and maintenance costs versus systems that use steam jackets or oil for heating.

Also in contrast to prior systems, instead of a double-wall jacket through which a flowing heating medium is supplied, the first kettle 12 has a single-wall jacket defining the outer circumferential surface 120. The induction coil 138 is wound around the outer circumferential surface 120 such that the induction coil 138 does not contact the outer circumferential surface 120 of the first kettle 12. For example, a bracket, cage, or other support structure can hold the induction coil 138 in place. In other examples, the induction coil 138 may be designed to be freestanding.

As shown in FIGS. 1 and 2, the induction coil 138 is disposed around a lower portion of the outer circumferential surface 120 of the first kettle 12, but not around an upper portion of the outer circumferential surface 120 of the first kettle 12. This allows the kettle 12 to be heated directly adjacent the location of its contents. Heating the upper portion of the kettle 12 may lead to burning of any contents that splash up onto the interior wall of the tank 118. Further, in contrast to prior systems, the vertical extent to which the kettle 12 is heated can easily be varied if two or more induction coils are provided or if the single induction coil is provided with multiple coil taps for heating certain sections of the coil but not others. This may allow for varied volumes of batches of grease to be made in the same kettle, with a smaller batch being heated by lower induction coils or a lower segment of a multi-tap induction coil, and a larger batch being heated by all of the induction coils or the entire multi-tap induction coil.

As noted briefly hereinabove, a second kettle 14 may be provided in fluid communication with the first kettle 12. Such fluid communication is provided by way of conveyance means 16 leading from the outlet 140 of the first kettle 12 to the inlet 236 of the second kettle 14. As will be discussed, at a certain point in the grease manufacturing process, the controller 56 is configured to control the power supply 42 to stop providing power to the induction coil 138 before contents of the first kettle 12 are transferred to the second kettle 14. Stopping providing power to the induction coil 138 immediately stops heating the first kettle 12, as opposed to requiring that a flowing heating medium first exit a double-walled jacket around the kettle. As was also noted hereinabove, the second kettle 14 may be identical to the first kettle 12, with one exception: the second kettle 14 does not have an induction coil wrapped thereabout. This is because the second kettle 14 is used for finishing (e.g., addition of more base oil and any desired additives), which generally requires no heat input.

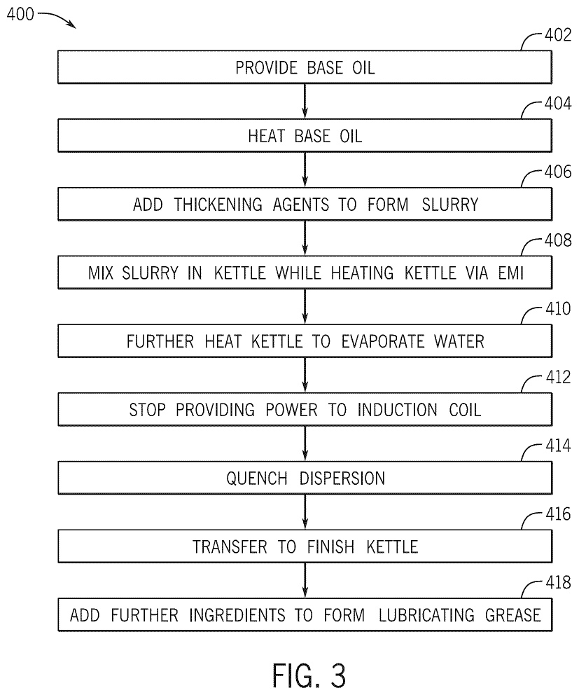

FIG. 3 illustrates a method 400 for producing a lubricating grease. The method 400 comprises providing a base oil as shown at 402 and heating the base oil as shown at 404. In one example, the base oil may be heated in a vessel separate from the first kettle 12, which separate vessel may also be heated via electromagnetic induction. In another example, the base oil is heated in the first kettle 12 via electromagnetic induction. For example, for a typical lithium soap-thickened grease, the base oil will be heated to approximately 100° F. The method 400 next includes adding one or more thickening agents to the heated base oil to form a slurry, as shown at 406. The thickening agents may be added via the hopper 132 and dispersed via the disperser into the base oil within the tank 118. In one example, the controller 56 controls the first motor 130a of the disperser according to a preprogrammed batch process defined in a batch processing module stored in the storage system of the controller 56.

As shown at 408, the method includes mixing the slurry in the first kettle 12 while heating the first kettle 12 via electromagnetic induction under conditions suitable to form a dispersion. As described with respect to FIG. 2, heating the first kettle 12 via electromagnetic induction comprises providing power to an induction coil 138 configured to heat the first kettle 12, and the method 400 further comprises controlling the power provided to the induction coil 138 with the controller 56. According to the preprogrammed batch process, the controller 56 may control the motors 130a-c during this step while at the same time controlling the power supply 42 to provide power to the induction coil 138. For example, for a lithium soap-thickened grease, the temperature of the contents of the first kettle 12 may be brought to approximately 180-190° F. using feedback control. This is hot enough to drive the saponification reaction and ensure the ingredients mix, but not yet hot enough to evaporate water.

In some processes, the thickening agent(s) will have been mixed with water prior to being added to the tank 118. In some processes, the one or more thickening agents may comprise two or more thickening agents, and the step of mixing the slurry in the first kettle 12 while heating the first kettle 12 causes the two or more thickening agents to react so as to form one or more reaction products. Particularly, one of the one or more reaction products comprises water (a byproduct of the saponification process). Thus, the method further includes heating the first kettle 12 via electromagnetic induction so as to evaporate the water from the dispersion as shown at 410. For example, the controller 56 may be programmed to heat the contents of the kettle 12 to approximately 212-215° F. so as to dehydrate the dispersion.

After the dispersion has been dehydrated, the controller 56 may be configured to increase the temperature of the contents of the kettle 12 by controlling the power provided to the induction coil 138 until the contents of the kettle are approximately 390-405° F. The controller 56 may be programmed to hold the temperature in this range via feedback control for about 15-20 minutes to cause all of the thickening agents (and, if applicable, their non-water reaction products) to be dispersed within the base oil. After this, the method 400 includes stopping providing power to the induction coil 138, as shown at 412, prior to a step of adding further ingredients to the dispersion. In some processes, the further ingredients include further amounts of the base oil, which are added to the dispersion within the first kettle 12 as shown at step 414 after the induction coil 138 is no longer provided with power so as to quench the dispersion. After the mixture is quenched to about 360° F., the method 400 includes subsequently transferring the quenched dispersion to the second kettle 14, as shown at 416. As shown at 418, the method 400 may include adding further ingredients to the dispersion under conditions suitable to form a lubricating grease, such as adding even further amounts of the base oil to the second kettle 14 to thin and further cool the mixture (e.g., to approximately 180° F.) and adding any additives to produce a desired end product. The controller 56 may control the motors 230a, 230b, 230c to mix the additional amounts of base oil and any additives together with the product that was transferred from the first kettle 12. As is known, the product in the second kettle 14 may then be transferred to a homogenizer or mill to break down the thickener and achieve a desired texture. The final lubricating grease product may then be packaged or stored in a silo for later packaging.

As noted, feedback control over the temperature of the contents of the first kettle 12 may be carried out during any of the heating steps described hereinabove. Thus, the method 400 may include monitoring a temperature of contents of the first kettle 12 with a temperature sensor 58 and comparing the temperature of the contents of the first kettle 12 to a predetermined setpoint temperature with the controller 56. The method 400 may also include controlling the power provided to the induction coil 138 so as to maintain the contents of the first kettle 12 within a predetermined range of the temperature setpoint. In one example, the predetermined range is five degrees Fahrenheit. More particularly, the predetermined range is two degrees Fahrenheit. The controller 56 may regulate output frequency of the power supply 42 as required for a particular process. In some examples, the output power level of the power supply 42 may be kept constant; in other examples, the power supply output power level (or voltage) can be changed by suitable means, such as pulse width modulation, along with the output frequency. For example, if the temperature of the contents of the first kettle 12 is too low, the output power level from the power supply 42 may be increased by increasing the voltage pulse width.

The microwave heating methods described in U.S. Pat. No. 8,962,542 work best with non-mineral oil-based greases, such as vegetable oil-based greases, because microwaves cause polar vegetable oils to vibrate through an omni-directional motion, resulting in rapid heat rise. The '542 patent discusses how mineral oils and non-polar liquids do not vibrate when exposed to microwaves, resulting in less heat generation. In contrast, the present electromagnetic induction-based heating system 10 and method 400 are agnostic of the polarity of the ingredients being heated. Thus, induction heating of the kettle 12 and its contents will be faster and more controllable than hot oil or steam-based heating regardless of the ingredients in the grease. Further, the present inventors have witnessed some microwave-heated greases lose integrity over time in the field. The present induction-heated greases do not suffer from such a drawback.

Using induction heating provides significant benefits over hot oil or steam heating. Floor space is maximized and complexity minimized, as the induction coil 138 is wrapped around the kettle 12 and no piping or valving is required to provide heated oil or steam to the kettle jacket. Induction heating reduces processing time by two to five times because the kettle 12 and its contents reach the desired temperature much more quickly than when hot oil or steam heating is used. Induction heating is also efficient and effective at higher temperatures, where oil or steam heating have traditionally not worked well. Further, as noted hereinabove, any cooling also occurs more quickly, as the induction coil 138 can be turned off instantaneously to stop heating the kettle 12. Thus, thermal inertia during both heating and cooling steps is significantly reduced. Further, typical hot oil systems have a boiler that heats the hot oil and hot oil lines first, after which the hot oil lines heat the kettle jacket. The boiler remains on and heats the oil even when the kettle jacket does not require heating. There is a loss of heating efficiency associated with this indirect method. In contrast, the induction coil 138 of the present disclosure directly heats the kettle 12 and can be provided with power only as needed, achieving nearly 100% heating efficiency. Finally, the boiler and hot oil lines of a traditional heating system contain heat transfer oil that is typically above 525° F. The heat transfer oil in the hot oil lines and boiler can inadvertently ignite due to the elevated temperatures and the flashpoint of the heat transfer oil. The heat transfer oil also poses a safety risk in terms of leaks in the system. Operators working on or around the boiler, hot oil lines, or with the heat transfer oil while at elevated temperature can be burned or injured if a leak occurs. The induction method removes the need for such heated oils and the inherent safety risk they pose.

In the present description, certain terms have been used for brevity, clarity, and understanding. No unnecessary limitations are to be implied therefrom beyond the requirement of the prior art because such terms are used for descriptive purposes only and are intended to be broadly construed. The different assemblies described herein may be used alone or in combination with other systems. Various equivalents, alternatives, and modifications are possible within the scope of the appended claims.

What is claimed is:

1. A method for producing a lubricating grease, the method comprising:
providing a base oil;
heating the base oil;
adding one or more thickening agents to the heated base oil to form a slurry;
mixing the slurry in a first kettle while heating the first kettle via electromagnetic induction under conditions suitable to form a dispersion; and
adding further ingredients to the dispersion under conditions suitable to form a lubricating grease.

2. The method of claim 1, wherein the one or more thickening agents comprise two or more thickening agents, and the step of mixing the slurry in the first kettle while heating the first kettle causes the two or more thickening agents to react so as to form one or more reaction products.

3. The method of claim 2, wherein one of the one or more reaction products comprises water, and further comprising heating the first kettle via electromagnetic induction so as to evaporate the water from the dispersion.

4. The method of claim 1, wherein heating the first kettle via electromagnetic induction comprises providing power to an induction coil configured to heat the first kettle, and the method further comprises controlling the power provided to the induction coil with a controller.

5. The method of claim 4, further comprising:
monitoring a temperature of contents of the first kettle with a temperature sensor;
comparing the temperature of the contents of the first kettle to a predetermined setpoint temperature with the controller; and
controlling the power provided to the induction coil so as to maintain the contents of the first kettle within a predetermined range of the predetermined setpoint temperature.

6. The method of claim 5, wherein the predetermined range is five degrees Fahrenheit.

7. The method of claim 5, wherein the predetermined range is two degrees Fahrenheit.

8. The method of claim 4, further comprising stopping providing power to the induction coil prior to the step of adding further ingredients to the dispersion.

9. The method of claim 8, wherein the further ingredients include further amounts of the base oil, and the method further comprises:
adding the further amounts of the base oil to the dispersion within the first kettle so as to quench the dispersion; and
subsequently transferring the quenched dispersion to a second kettle and adding even further amounts of the base oil to the second kettle.

10. The method of claim 4, wherein the induction coil is disposed around an outer circumferential surface of the first kettle.

11. A system for producing lubricating grease, the system comprising:
a first kettle configured to receive a base oil and one or more thickening agents therein, the base oil and the one or more thickening agents together forming a slurry;
an induction coil disposed around an outer circumferential surface of the first kettle; and
a power supply electrically coupled to the induction coil and configured to provide power to the induction coil so as to heat the first kettle;
wherein the first kettle is configured to mix the slurry while the first kettle is heated via electromagnetic induction under conditions suitable to form a dispersion.

12. The system of claim 11, further comprising a controller configured to control the power supply.

13. The system of claim 12, further comprising a temperature sensor configured to sense a temperature of contents of the first kettle;
wherein the controller is configured to compare the temperature of the contents of the first kettle to a predetermined setpoint temperature; and
wherein the controller is configured to control the power supply so as to control the power provided to the induction coil to maintain the contents of the first kettle within a predetermined range of the predetermined setpoint temperature.

14. The system of claim 13, wherein the predetermined range is five degrees Fahrenheit.

15. The system of claim 13, wherein the predetermined range is two degrees Fahrenheit.

16. The system of claim 12, further comprising a second kettle in fluid communication with the first kettle;
wherein the controller is configured to control the power supply to stop providing power to the induction coil before contents of the first kettle are transferred to the second kettle.

17. The system of claim 11, wherein the first kettle has a single-wall jacket defining the outer circumferential surface.

18. The system of claim 11, wherein the induction coil is disposed around a lower portion of the outer circumferential surface of the first kettle, but not around an upper portion of the outer circumferential surface of the first kettle.

19. The system of claim 11, wherein the induction coil does not contact the outer circumferential surface of the first kettle.

20. The system of claim 11, wherein the first kettle further comprises a motor-driven agitator for mixing contents of the first kettle.
